(19) United States
(12) Patent Application Publication
(10) Pub. No.: US 2011/0246381 A1
(43) Pub. Date: Oct. 6, 2011

(54) SYSTEMS AND METHODS OF MODELING ENERGY CONSUMPTION OF BUILDINGS

(76) Inventors: Aide Audra Fitch, Austin, TX (US); Robert Barry Howard, Dallas, TX (US)

(21) Appl. No.: 12/750,223

(22) Filed: Mar. 30, 2010

(51) Int. Cl. G06Q 10/00; G06F 7/44; G06F 7/42; G06Q 50/00

(52) U.S. Cl. 705/313; 703/2; 705/348; 703/6

(57) ABSTRACT

A modeling system is configured to model a building from incomplete physical constraint information. When initial user input related to the proposed building is received that identifies a building type, a location, and a square footage, the modeling system retrieves a baseline factor based on the user input and multiplies it by the square footage to produce a baseline energy usage model. As additional user inputs are received that further define the proposed building, efficiency factors are selectively applied that model the energy usage impact related to particular user inputs to produce an adjusted energy usage model, which can be compared to the baseline energy usage model.

### FIELD

The present disclosure is generally related to systems and methods of modeling energy consumption of buildings. More particularly, the present disclosure relates to a system designed to assist investors and construction professionals to predict energy usage, sustainability and costs for a building, based on incomplete building information, to facilitate decision-making before starting a construction project.

### BACKGROUND

A number of computer programs are commercially available to estimate energy performance and/or cost performance of buildings. Such programs are known variously by terms such as energy modeling, simulation, building information modeling (BIM), construction cost calculators, energy assessment tools, life-cycle assessment tools, life-cycle cost calculators, and the like. With respect to energy modeling tools, such computer programs are designed to model energy consumption of a project with respect to one or more of the following factors: building layout (such as the orientation and placement of a building on a lot), material selection (such as the types of windows and other construction materials), system design (such as HVAC (heating, ventilating, and air-conditioning, security systems and other systems), plug and process loads (energy used for computers, audio-visual, manufacturing, and other non-building related uses), and equipment selection (such as the choice of equipment for implementing selected designs and systems).

In general, such computer programs can be used to assist in a decision-making process such that the finished project meets appropriate environmental goals while at the same time meeting a builder's requirements of profitability. In some cases, energy simulation analyses are used to justify increased construction costs associated with “higher efficiency” equipment when such computer programs indicate that the life-cycle savings of such equipment provide an acceptable return on investment (ROI).

Unfortunately, modeling buildings with such software requires engineering time to configure the input data files, run the simulations, and analyze the output. Configuring the input data files can be complex and typically requires a significant amount of detail about the project. In some instances, such programs require three-dimensional CAD drawings as a starting point. However, at the point in the construction project when energy analysis computing systems can provide the most benefit, such as when the project is still at a conceptual stage and before drawings have been commissioned, many of the details may be unknown. Accordingly, to complete the modeling process at such a stage, the user may estimate a large number of details. In such cases, the accuracy of the model generated by the modeling software is highly dependent on the knowledge of the person providing the estimates and the resulting life-cycle and cost models can have significant margins of error.

Additionally, the amount of time to model a building varies with the analysis software used, the complexity of the building, and the level of detail used in the model. Accurate modeling typically requires significant detail and setup time. However, since the engineering time to configure the data files and to model the project adds cost to a project, time spent on such modeling is often kept to a minimum. Unfortunately, less time spent during set up can also lead to further uncertainty in the resulting output models. If the configuration of the modeling software is short-changed, inaccuracy of the model is all but ensured, and the software's value to the decision-making process is reduced.

Thus, such modeling software is often not used at the point in the construction process where such information could provide the largest benefit, i.e., while the project is still at a conceptual stage and before architects are even involved. Conventional modeling systems typically require too much information to be reliably used when the construction project is still at a conceptual stage. If the user attempts to model a construction project based on his/her best guesses and such guess are inaccurate or incomplete, the modeling systems will produce cost-estimates having large uncertainty and potential omissions that can result in devastating and costly errors. Accordingly, such software is often used after design is completed and after significant planning costs have already been incurred.

### SUMMARY

Systems and methods of modeling a building are disclosed that produce energy usage models based on incomplete or complete physical constraint information about the building. When initial user input related to the building is received that identifies a building type, a location, and a square footage, the modeling system retrieves a baseline factor based on the user input and multiplies it by the square footage to produce a baseline energy usage model. As additional user inputs are received that further define the proposed building model, efficiency factors are selectively applied that model the energy usage impact related to particular user inputs to produce an adjusted energy usage model for the proposed building model, which can be compared against the baseline model.

In an embodiment, a method of modeling energy consumption of a building from incomplete physical constraint information includes receiving a user input identifying a structure usage type, a square footage, and a geographic zone associated with the building at a modeling system from a user device. The method further includes automatically selecting a baseline value from a plurality of baseline values based on the geographic zone and the structure usage type and generating a baseline energy model associated with the building by multiplying at least a portion of the square footage by the baseline value using the modeling system.

### BRIEF DESCRIPTION OF THE DRAWINGS

FIG. 1 is a block diagram of an embodiment of a system to generate baseline energy usage factors, error margins, and efficiency factors for various buildings using one or more modeling tools.

FIG. 2 is a flow diagram of an embodiment of a method of generating percentage performance efficiency factors.

FIG. 3 is a flow diagram of an embodiment of a method of generating margins of error for each of the percentage performance efficiency factors.

FIG. 4 is a flow diagram of an embodiment of a method of generating weighted mean estimates based on percentage performance efficiency factors, error margins and baselines for various buildings.

FIG. 5 is a diagram of a representative example of multiple tables including a table of energy usage values for baseline building models and for the baseline building models including various energy efficiency factors produced using different modeling tools.

FIG. 6 is a block diagram of an embodiment of a modeling system configured to model energy usage, construction costs, and operational costs for a building using baselines, efficiency factors, and associated margins of error.

FIG. 7 is a block diagram of an expanded view of the modeling system of FIG. 6 and including an expanded view of the data sources.

FIG. 8 is a block diagram of a second embodiment of a modeling system configured to model energy usage, construction costs, and operational costs for a physical structure.

FIG. 9 is a flow diagram of a second embodiment of a method of modeling energy usage, construction costs, and operational costs for a physical structure.

FIG. 10 is a diagram of an embodiment of a user interface that may be produced by the modeling systems of FIGS. 6-9 to receive user input related to a physical structure and to provide reports related to the modeled energy usage, construction costs, and operational costs for the physical structure.

In the following description, the use of the same reference numerals in different drawings indicates similar or identical items.

### DETAILED DESCRIPTION OF ILLUSTRATIVE EMBODIMENTS

Embodiments of a system for modeling energy usage and costs for proposed buildings based on user inputs, such as building usage type, square footage, and geographic location or zone, which provide less than a complete characterization of the proposed building. A robust database of unitized energy baselines (energy use per square foot) is derived through modeling and/or compiling real building data for buildings of different shapes, sizes, uses, and locations.” The modeling system is configured to utilize the database to determine annual energy usages for each building model and by dividing the annual energy usage by a square footage of the building model. The system is configured to select a unitized baseline and to multiply the unitized baseline by a square footage from the user input to produce substantially instantaneous baseline modeling results, including baseline environmental and economic impact models.

Further, the system allows the user to add additional details, as desired, to see how changes can alter the environmental impact and the cost impact of the building and/or to refine the profile of the building to improve the accuracy of the model. The system selects one or more efficiency factors from a plurality of efficiency factors based on the additional details, multiplies the one or more efficiency factors by the square footage, and adjusts the baseline environmental and economic impact models based on the product to produce adjusted environmental and economic impact models for the building. The term “efficiency factor” refers to a percentage change in energy consumption attributable to a particular energy efficiency strategy or design choice associated with a proposed building, which percentage change is normalized over the square footage. The term IMPACT FACTOR™ is a proprietary term used by the assignee of the present application to refer to such efficiency factors and to other factors that might impact energy consumption, costs, return on investment, cash flow, environmental impacts, or other parameters of a proposed building based on the user's design choices for a proposed building.

In some instances, the system provides a user interface that includes baseline and adjusted models, allowing a user to view them side-by-side. Visual indicators provide readily understandable information about a particular model relative to the baseline model. Additionally, the modeling system is configured to provide margins of error relative to the various environmental and cost impact models, so that the user can incorporate such error margins into the planning process.

As discussed below in greater detail, the modeling system is configured to utilize pre-configured, unitized baseline factors and a plurality of efficiency factors (representing percentage performance efficiency, energy-usage reduction factors) to provide environmental impact models based on limited information from a user and based on each additional piece of information provided by the user. The plurality of efficiency factors are produced by modeling building profiles with selected environmental strategies using one or more software modeling tools and by determining a percentage contribution attributable to each of the selected environmental strategies and by normalizing the percentage contribution over a square footage of the building profile to produce a unitized efficiency factor for each energy efficiency strategy.

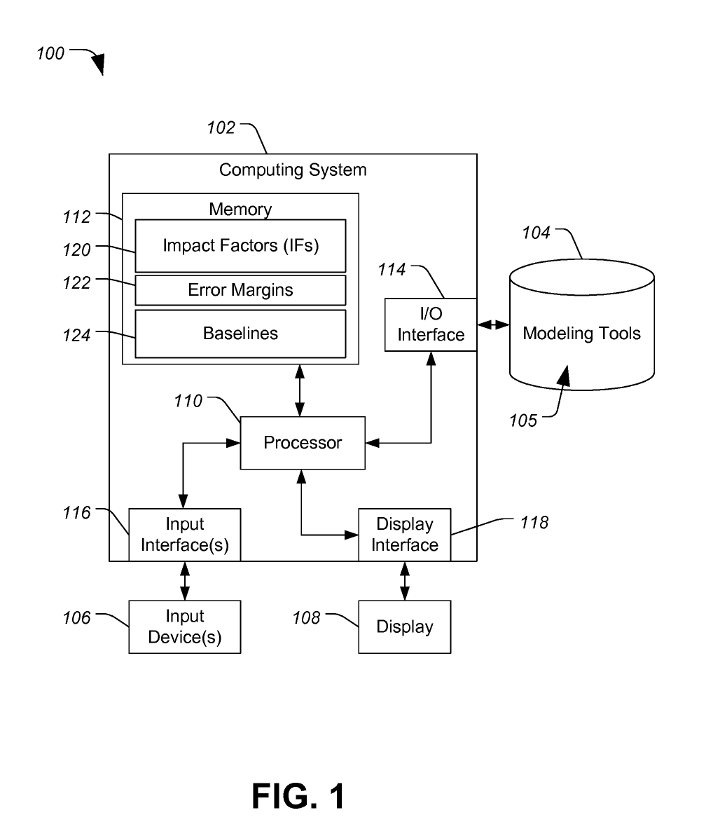

FIG. 1 is a block diagram of an embodiment of a system 100 to generate efficiency factors 120, error margins 122, and baselines 124 for various building models using one or more modeling tools, such as modeling tools 105 stored in a database (or memory) 104. In some instances, database 104 can be distributed across multiple servers. In other instances, database 104 can be included within memory 112.

System 100 includes a computing system 102, which is communicatively coupled to a database 104. Computing system 102 can be a personal computer, multiple servers interconnected to process large amounts of data, or a portable computing device having sufficient processing power and memory capacity to model energy usage of a building. Computing system 102 is coupled to one or more input devices 106 (such as a keyboard, a mouse, a scanner, and the like) to receive user input and to a display 108 (such as a liquid crystal display (LCD), a monitor, another type of display, and the like) to display information.

Computing device 102 includes a processor 110 and a memory 112 accessible to processor 110. Further, computing device 102 includes an input/output (I/O) interface 114 that is configured to communicate with the data store 104. Additionally, computing device 102 includes one or more input interfaces 116 to receive input from one or more input devices 106 and includes a display interface 118 to provide data to display 108.

In operation, a user may select modeling tools for modeling a building profile. Alternatively, memory 112 may include instructions executable by the processor 110 to iteratively select modeling tools, adjust parameters, and model energy usage for various building profiles. The user supplies the complete physical profile of the building using one or more input devices 106 and applies the selected one of modeling tools 105 to the building to produce a baseline energy usage value. The baseline energy usage value is then divided by a square footage of the building to produce a unitized baseline factor for the building. The process is repeated for different building sizes and types using the same modeling tool and then using other modeling tools. Thus, a plurality of unitized baseline factors are produced and stored in memory 112 as baselines 124.

In one particular example, baseline building models are produced using industry standards, such as ASHRAE 90.1-2007, to define the characteristics of a baseline building model, including amount of insulation, efficiency of equipment, etc. The energy performance of this baseline model is calculated using a selected one of the plurality of modeling tools 105, such as the DOE-2 energy usage modeling tool, to produce a total annual energy usage value for the baseline model building, which total annual energy usage value is divided by the square footage of the model building to yield the unitized baseline or standard unitized baseline, which may be expressed in kilowatt hours per year per square foot (kWh/yr/SF). The unitized baseline is stored together with building type and optionally location data in memory 112 as baselines 124. Subsequently, the system 100 can use a correct unitized baseline from baselines 124 for a type of building specified by a user and multiply it by the square footage of the user's building (kWh/yr/SF×SF) to yield a total estimated energy usage (kWh/yr) for the user's building.

Further, an array of energy efficiency strategies are applied to each of the baseline models, one at a time (and some in combination). The new energy usage is calculated for the adjusted building model using a selected one of the plurality of modeling tools 105, such as the DOE-2 modeling tool. The margin of improvement attributable to the applied energy efficiency strategy is calculated ((Baseline usage−improved usage)/baseline usage) to yield a percentage factor referred to as the efficiency factor, which are stored in memory 112 as efficiency factors 120.

It is understood that each modeling tool applied to model a particular building and/or energy efficiency strategy may produce a different energy usage value. Accordingly, the resulting energy usage values for a given building profile are compared to determine a margin of error. The margins of error are determined for each of the building profiles and for each energy efficiency strategy. The results are stored in memory 112 as error margins 122.

Further, the process may be repeated using different geographic locations, producing geographically specific baselines, efficiency factors, and associated error margins. Further, in some instances, actual buildings and real energy usage data may be used to improve the accuracy of the baselines and the efficiency factors by modeling the actual building using the baseline and efficiency factors to produce a set of theoretical results and comparing the set of theoretical results to actual data. Error margins may be adjusted for each of the different modeling tools 105 and for each of the baselines 124 and efficiency factors 120 by comparing the predicted values to actual energy usage data collected from existing structures from which some of the building profiles may be derived.

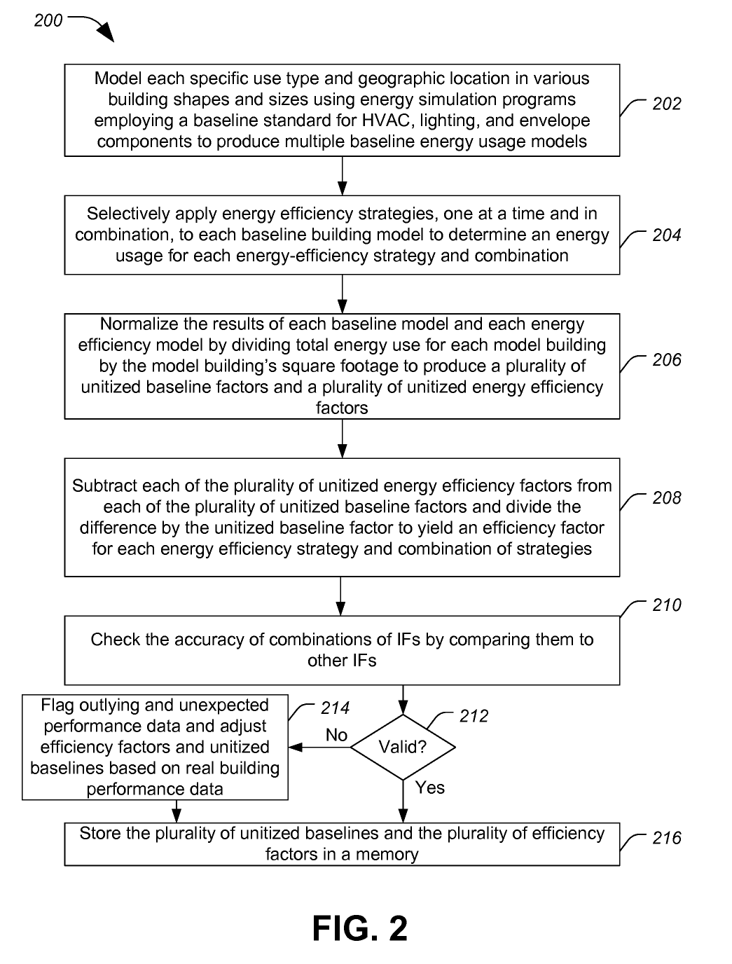

The modeling of each of the buildings using computing system 102 may sometimes include providing computer-aided architectural diagrams (CAD) drawings to computing system 102 using one of the input devices 106, such as a scanner. Further, the modeling tools in data store 104 may include a variety of conventional modeling tools, such as the Department of Energy's environmental impact modeling tool (DOE-2 or DOE-II), a newer version, such as the Department of Energy's Energy Plus energy modeling tool, and other tools, which provide reliable environmental impact models. Such tools may estimate energy usage, carbon footprint, utility usage (energy, water, etc.), land usage, and other environmental parameters. However, such tools require significant data inputs to provide reliable models. By applying the modeling tools to a variety of buildings, building usage types, envelope materials, systems, and material selections, multiple models are created and the various models are then normalized and processed to produce baselines 124 and efficiency factors 120. An example of one method of creating baselines 124 and efficiency factors 120 is discussed below with respect to FIGS. 2-4.

FIG. 2 is a flow diagram of an embodiment of a method 200 of generating efficiency factors. At 202, each specific use type and geographic location for a building are modeled in various building shapes and sizes using existing energy simulation programs (and/or cost modeling programs) employing baseline building standards for HVAC, lighting, systems and envelope components (such as building standards promulgated by the American Society of Heating, Refrigerating and Air-Conditioning Engineers (ASHRAE), including the building code standards commonly referred to as ASHRAE 90.1-2007) to produce multiple baseline energy usage models. Each baseline energy usage model represents an energy efficiency model of a building that satisfies current building codes for the selected geographic region. The specific use type represents the use intended for the building, such as “office,” “restaurant,” “retail,” “multifamily residential,” “industrial,” or some combination of thereof, which use type may have different baseline parameters, which parameters may be defined by building codes or standards for such building types. Further, the geographic region is taken into account, since environmental performance can vary based on the environment in which the building is to be constructed.

Advancing to 204, energy efficiency strategies are selectively applied, one at a time and in combination, to each baseline building model to determine an energy usage for each energy-efficiency strategy and combination. For example, selecting a particular type of roof-insulation, a particular type of envelope material, particular types of windows, percentage of windows, water reclamation strategies, and other variations can impact the energy-efficiency model of the building.

Continuing to 206, the results of each baseline model and each energy efficiency model are normalized by dividing total energy usage for each model building by the model building's square footage to produce a plurality of unitized baseline factors and a plurality of unitized energy efficiency factors. By normalizing the results over the square footage, the energy efficiency model can be simplified to a numeric value (a unitized value), which can be used to estimate an environmental impact for other buildings based on square footage information.

Continuing to 208, each of the plurality of unitized energy efficiency factors are subtracted from each of the plurality of unitized baseline factors, and the difference is divided by the unitized baseline factor to yield an efficiency factor for each energy efficiency strategy and combination of strategies. In an example, each efficiency factor represents a percentage performance efficiency gain attributable to one or more of the energy efficiency strategies.

Moving to 210, the accuracies of combinations of the efficiency factors are checked (verified) by comparing them to other efficiency factors. In particular, deviations (such as outlying or unexpected results) are analyzed to determine if the results are valid If the difference or deviation exceeds a threshold, the margin of error of a given efficiency factor for an individual energy strategy may be outside of an acceptable margin of error.

At 212, if the efficiency factor or a baseline is outside of an acceptable margin of error (i.e., is not valid), the method advances to 214 and outlying and unexpected performance data are flagged and the efficiency factor or baseline for the individual efficiency strategy is adjusted based on real building performance data. In some instances, the efficiency factors and/or the baselines may be manually adjusted. Alternatively, the individual efficiency factor can be replaced or the modeling can be performed again to correct for results that are anomalous. Once adjusted (at 214) or if the efficiency factor is within the margin of error (at 212), the method proceeds to 216 and the plurality of unitized baselines and the plurality of efficiency factors are stored in a memory.

In some instances, the different unitized baselines for a given building produced using different modeling tools may be averaged to produce an average unitized baseline for a given building type in a given location or geographic zone. The average unitized baseline data may be calibrated with real project case studies to produce the margins of error, providing a true representation of accuracy and greater predictability than standard thermal transfer analyses.

In the above-described system, different modeling software may be separately applied to each building model and to each combination of energy efficiency strategies for different building types and sizes to produce a plurality of unitized baselines and a plurality of efficiency factors for each of the multiple modeling tools. The method 200 may be performed iteratively, processing each building profile and its variations using each available modeling tool.

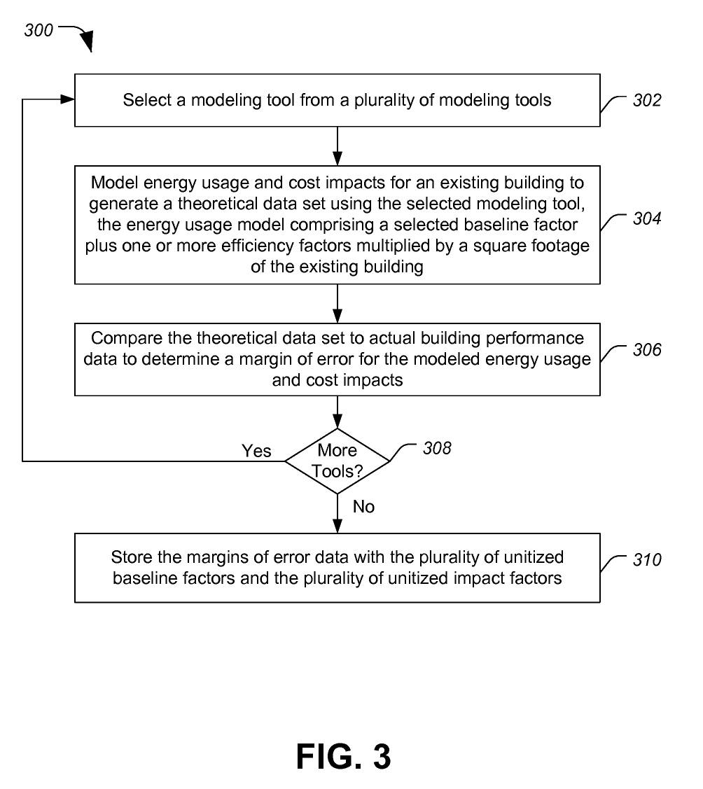

As previously mentioned, the resulting energy usage models include some margin of error, whether or not the modeling tool recognizes the possibility of such an error. Since the plurality of unitized baselines and the plurality of efficiency factors include the possibility of such error margins, it is desirable to include reliability estimate or error margin data. Accordingly, a method of determining a margin of error for a given unitized baseline and one or more efficiency factors using real building case studies is described below with respect to FIG. 3.

FIG. 3 is a flow diagram of an embodiment of a method 300 of generating margins of error for each of the percentage efficiency factors. At 302, a modeling tool is selected from a plurality of modeling tools (such as the modeling tools stored in data store 104 depicted in FIG. 1). Advancing to 304, energy usage and cost impacts are modeled for an existing building to generate a theoretical data set using the selected modeling tool, using a selected baseline factor plus one or more efficiency factors multiplied by a square footage of the existing building. In particular, a user may access a user interface to enter building information, including square footage, location, building type, and other information, such as one or more energy efficiency strategies associated with the building.

Continuing to 306, the theoretical data set is compared to actual building performance data to determine a margin of error for the modeled energy usage and cost impacts. In particular, real building case studies are modeled using the baselines and efficiency factors to generate the theoretical data sets, which are then compared to the actual building performance data to determine a margin of error for the simulation tool. If the margin of error is too large, the data may be examined to adjust the selected baseline and/or the one or more efficiency factors. Additionally, if the margin of error is too large, the input data may be examined for errors and/or omissions.

The process is repeated utilizing more than one existing energy simulation tool or method. In particular, moving to 308, if there are more simulation tools or methods, the method returns to 302 and another modeling tool is selected from the plurality of modeling tools. Otherwise, the method proceeds to 310 and the margins of error data are stored with the plurality of unitized baseline factors and the plurality of unitized efficiency factors in memory. In an embodiment, the margins of error are stored with their corresponding baselines and efficiency factors.

It should be understood that the margins of error are related to the tools at this stage. However, the margins of error should be correlated to the normalized baselines and the efficiency factors so that they can be readily applied to estimate environmental and cost impacts for other buildings. In one embodiment, the baselines, the efficiency factors, and the margins of error are reviewed by a professional engineer. For each data point, the engineer produces a mean or professional “best-guess” substitute value, which may be derived from real case studies of building performance. In another embodiment, the baselines, efficiency factors, and margins of error are averaged to produce average baseline, average efficiency factor, and average error margin data.

In one example, performance data from real building case studies can be collected and added to the tabulated data sets to weight the mean toward real-life performance. In this instance, the real performance data is used to train or enhance the efficiency factors and baselines, improving the accuracy of the predicted environmental and cost impact reports.

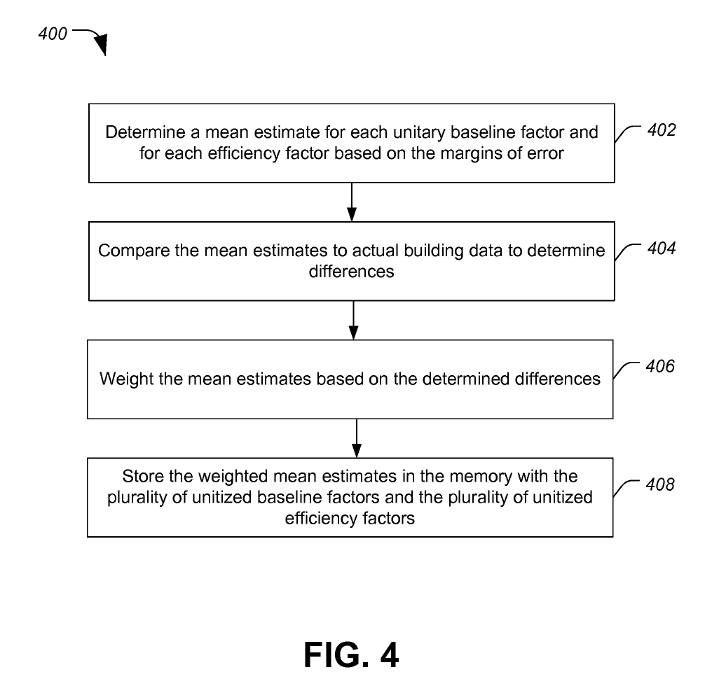

It is possible to generate such mean or best-guess substitute values automatically using a computing system, such as computing system 102 depicted in FIG. 1. In some instances, the computing system 102 may include instructions executable by processor 110 to analyze the tabulated data points and to weight the data points based on real performance data. An example of a method that can be implemented on the computing system 102 is depicted in FIG. 4.

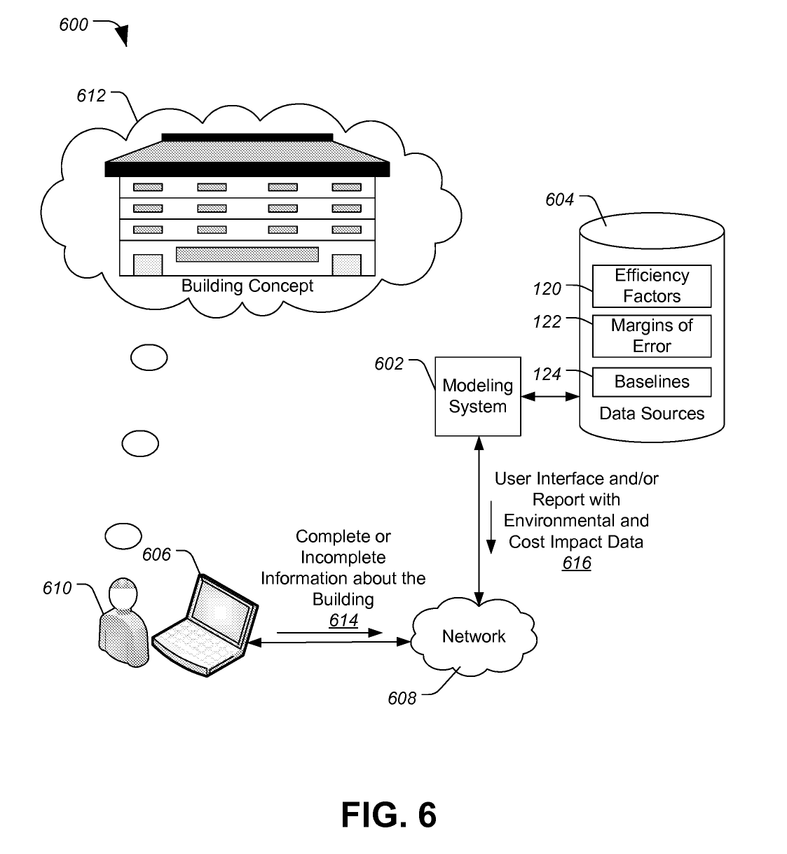

FIG. 4 is a flow diagram of an embodiment of a method 400 of generating weighted mean estimates based on percentage performance efficiency factors, error margins and baselines for various buildings. At 402, a mean estimate for each baseline and for each efficiency factor is determined based on the margins of error. Continuing to 404, the mean estimates are compared to actual building data to determine differences. Advancing to 406, the mean estimates are weighted based on the determined differences. Moving to 408, the weighted mean estimates are stored in the memory the plurality of unitized baseline factors and the plurality of unitized efficiency factors, which can be used by a computing system, such as computing system 102 depicted in FIG. 1 or computing system 602 depicted in FIG. 6, to model environmental and cost impacts of a building based on limited input data received from a user. FIGS. 6-10 illustrate aspects of a system to model such environmental and cost impacts of a building using the pre-configured baselines, the efficiency factors, and the associated margins of error.

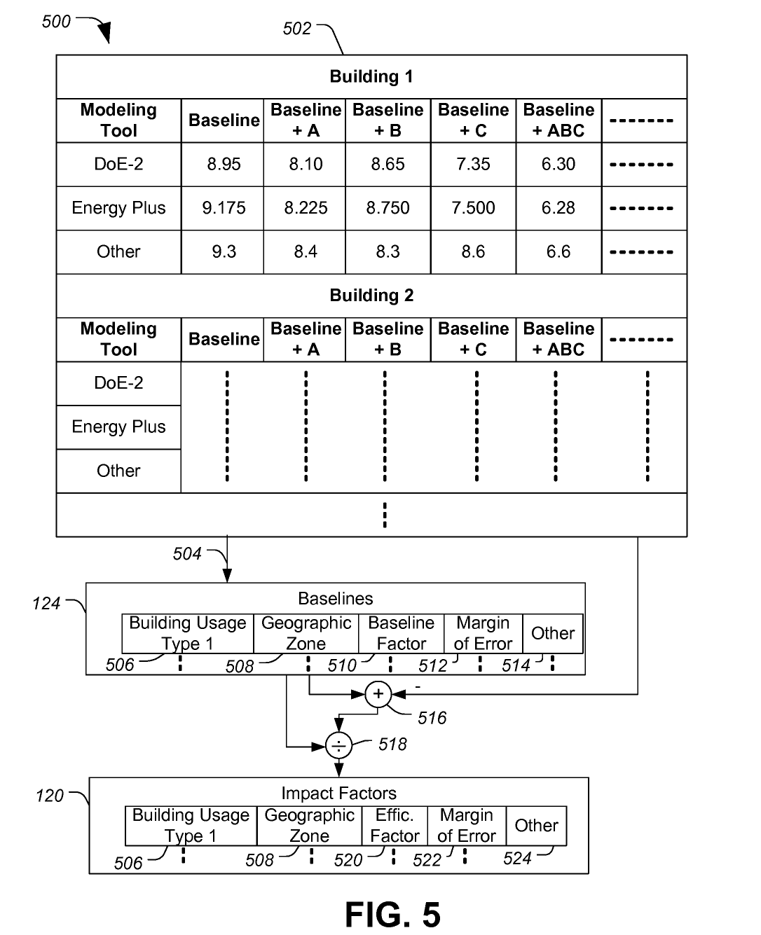

FIG. 5 is a diagram of a representative example of multiple tables 500 including a table of energy usage values for baseline building models and for the baseline building models including various energy efficiency factors produced using different modeling tools. Tables 500 include an energy usage table 502, baselines 124 and efficiency factors 120. Energy usage table 502 includes unitized baseline energy usage values and unitized energy usage values for the baseline model plus one or more energy efficiency strategies, which values are normalized by square footage values. Each baseline building model (Building 1, Building 2, etc.) is modeled using multiple modeling tools, such as the Department of Energy (DOE) energy modeling tool DOE-2, Energy Plus, or other energy modeling tools.

Each building model represents a complete building profile that satisfies the building codes for a particular geographic region to produce a baseline energy usage value. The building model is created using one or more industry standards, such as the ASHRAE 90.1-2007 standard. The energy usage value is divided by the square footage of the building model to produce a performance energy factor having units of kWh/yr/SF. In this example, the unitized baseline factor for Building 1 determined using the DOE-2 modeling tool is 8.95 kWh/yr/SF.

Various energy efficiency strategies (A, B, and C) are added individually and in various combinations, such as A+B, A+C, B+C, A+B+C, etc, and each of the modeling tools are applied again to determine an energy usage factor for each of the building models. For example, energy efficiency strategy A can include R-31 roofing insulation or a radiant barrier, as compared to R-19 insulation required by the building code for the particular region. Energy efficiency strategy B could be solar water heaters, as compared to gas or electric water heaters as required by the building code for the particular region, and so on. Any number of energy efficiency strategies can be modeled alone and in combination to produce energy usage values, which can be divided by the square footage to produce a plurality of energy usage factors.

Once the unitized baselines and the unitized energy usage values are calculated, the unitized baselines and efficiency factors can be determined. In an example, the unitized baselines determined for a particular building using different modeling tools may be averaged to produce an average unitized baseline. Alternatively, one of the multiple unitized baselines can be selected based on its relative accuracy when compared to real data. In general, the determination process is indicated at 504, and the resulting unitized baseline for a given building model in a particular location is then stored in memory as baselines 124.

The baselines 124 include an associated building type identifier 506, such as residential, retail, office space, etc. Further, baselines 124 include a geographic zone 508, the baseline factor 510, an associated margin of error 512, and optionally other data. Such other data may include update information, such as when the particular baseline factor was last verified or last adjusted based on real building data.

Further, efficiency factors can be determined for each energy efficiency strategy by subtracting each energy usage factor for each of the energy efficiency strategies from the baseline factor 510 at 516 to produce a difference. The difference is then divided by the baseline factor at 518 to produce an efficiency factor, which is a percentage energy efficiency improvement that is attributable to the particular energy efficiency strategy or combination of strategies. For example, the efficiency factor for the Baseline plus an energy efficiency factor (A) building model associated with the Building 1 model using the DoE-II tool would be calculated as follows:

$$Energy Efficiency A = \frac{8.95 - 8.10}{8.95} = 0.09497 = 9.497 \% \qquad ( Equation 1 )$$

Alternatively, if the baseline factor is averaged, the average baseline value may be 9.14 and the average Baseline plus the energy efficiency factor (A) building model value may be 8.24. In this instance, with these values applied using Equation 1 produces an efficiency factor_{A} value of approximately 0.09846 or approximately 9.8%.

The resulting efficiency factor is stored as efficiency factors 120. In the illustrated embodiment, efficiency factors 120 include building usage type 506, geographic zone 508, an efficiency factor 520, an associated margin of error, and optionally other data 524. In an example, the other data 524 can include update information indicating the last time the efficiency factor 520 was modified.

It should be understood that the numbers depicted in table 502 and used in Equation 1 are fictitious numbers provided for illustrative purposes only.

While only three modeling tools (DoE-2, Energy Plus, and Other) are shown, it should be understood that any number of modeling tools can be used to refine the baselines and/or efficiency factors. Additionally, while a mean or average of baselines and efficiency factors are discussed above, certain modeling tools may have a lower margin of error relative to other modeling tools (as compared to real data), and their corresponding performance efficiency factors may be weighted more than those from the other modeling tools to determine the baselines 124 and efficiency factors 120. For example, if Energy Plus has a lower margin of error in its energy usage calculations as compared to DoE-2 and other modeling tools, the Energy Plus may be weighted more heavily than the results from the modeling tools to produce baselines 124 and efficiency factors 120.

Further, while table 502 depicts only two buildings, it should be understood that a variety of buildings having different usage types (residential, commercial, retail, industrial, or some combination thereof), different square footages, and different geographic locations may be modeled to produce a wide range of unitized baselines and unitized efficiency factors, which can be applied to model new buildings based on the usage type and geographic region information, as discussed below with respect to FIGS. 6-9.

FIG. 6 is a block diagram of an embodiment of a modeling system 600 configured to model energy usage, construction costs, and operational costs for a building using baselines 124, efficiency factors 120, and associated margins of error 122. System 600 includes a modeling system 602 that is communicatively coupled to one or more data sources 604, including pre-configured mean energy usage information, baselines 124, efficiency factors 120, and margins of error 122. Additionally, modeling system 602 is communicatively coupled to one or more user devices, such as user device 606 through a network 608, such as the Internet. User device 606 may be a portable computer, a personal digital assistant (PDA), a phone, or other electronic device having a processor and having access to network 608.

In operation, a user 610 with a building concept 612 accesses a user interface associated with modeling system 602 through network 608 via user device 606. Modeling system 602 provides a user interface to user device 606. In an example, the user interface may be rendered within an Internet browser application and displayed on a display of user device 606. User 610 interacts with the user interface through an input interface, such as a keyboard, track pad, or mouse of user input device 606 to provide information 614 about the building, which information 614 is sent to modeling system 602 through network 608. Information 614 can be a complete or incomplete building profile for the building concept 612. In some instances, information 614 can include digital images such as computer-aided design images. In other instances, information 614 includes only square footage, building usage type, and geographic zone (location) information.

Modeling system 602 is adapted to access the pre-modeled performance data (such as baselines 124, efficiency factors 120, margins of error 122, and other data) stored in the one or more data sources 604, to select the data set from the one or more data sources 604 that most closely resembles the building concept 612 defined by information 614, and to estimate environmental and cost impacts by multiplying by the input square footage by the selected data set. As will be discussed in greater detail below, the impacts are calculated using the selected one of baselines 124 and one or more of the efficiency factors 120 that most closely resemble information 614. Once calculated, modeling system 602 generates a user interface and/or a report 616 with predicted environmental and cost impact data for the building concept. The user interface and/or report 616 can be provided to user device 606 through network 608.

User 610 can interact with the user interface presented on user device 606 to modify the user inputs and further to define the building information, which causes the report information to change in real time or near real time. In some instances, the adjustments may be performed using embedded scripts within the user interface. In other instances, the user device 606 may communicate changes to modeling system 602 and receive updated information from modeling system 602 to update the environmental and cost impact data shown within the user interface on user device 606. In a particular example, each possible efficiency factor for a particular building type and location may be embedded within the user interface or report 616 so that user inputs can be processed instantaneously within the user's Internet browser application to provide updated environmental and cost impact data.

In a particular example, the user 610 provides a geographic location, building usage type, and square footage to modeling system 602. Modeling system 602 selects a baseline factor that is closest to the user input (based on the building type and location) and calculates environmental and cost impacts by applying the selected baseline to the square footage provided by the user. As the user 610 make subsequent changes, modeling system 602 may selected impact from data sources 604 (or access imbedded efficiency factors) to update the environmental and cost impacts. In one instance, the efficiency factors are applied to the existing baseline model to adjust the environmental and cost impacts relative to the existing baseline.

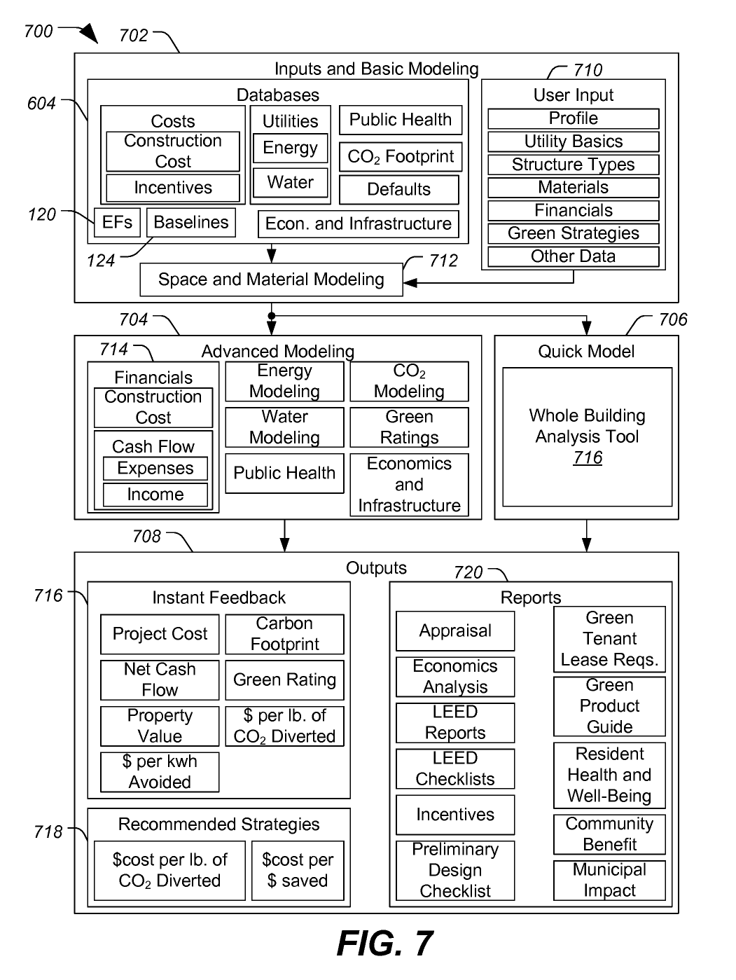

FIG. 7 is a block diagram of a second embodiment of a modeling system 700 configured to model energy usage, construction costs, and operational costs for a physical structure. System 700 includes an inputs and basic modeling component 702, which is coupled to both an advanced modeling component 704 and a quick modeling component 706, both of which are coupled to an output component 708.

Inputs and basic modeling component 702 includes databases 604, a user input module 710, and a space and material modeling system 712. Databases 604 include costs data, including construction costs and incentives. The construction costs include the construction cost of each major building component and environmental strategy or option (“green” option), which costs are collected and updated on a regular basis through various sources. Such sources can include cost references (such as “RS Means Cost Data” and other reference sources), consultants, partners in the construction industry, real building case studies, and other sources. Further, such construction cost data may also include data collected through voluntary cost data provided by customers or others in the construction or building management industries. Within costs data 604, the cost information can be normalized relative to a national average. Later, during modeling, a user-input multiplier is applied by space and material modeling 712 to adjust costs for regional or market conditions. Since default cost data is updated regularly, the costs data can be used to provide an easily accessible cost estimating tool for users of the system 700.

Costs data further includes incentives data, which can include a compilation of tax credits, tax deductions, grants, rebates, and other financial benefits or incentives provided by various governmental and non-governmental entities for environmental (or “green”) strategies, revitalization efforts, and other opportunities. Incentives are organized by federal, state, and city-specific offerings and include data related to qualifying entities. Provided the user of the system qualifies for a possible incentive, the incentive is automatically incorporated in cost calculations whenever relevant green strategies, location, and other parameters are triggered. Incentives data are updated regularly to offer customers an easy, one-stop clearinghouse for all green incentives, and may be used by advanced modeling tool 704 to recommend particular strategies.

Databases 604 also include utility data, including energy data and water data. The energy data can include pricing rates for electricity and/or gas in various user locations. Further, the energy data can include baseline energy usage for typical fixtures and building usage types.

The water data includes a compilation of baseline water use for typical fixtures and equipment, as well as reduced water use for low-water (“green”) fixtures and equipment. Further, water data includes information related to the water collection potential for rainwater and grey water collection systems. Pricing rates for water and wastewater in various user locations are also provided. Water use and conservation potential is calculated in various ways. All such energy and water data is updated regularly based on available information.

For building plumbing fixtures, a default number or user-provided number of occupants for each space is multiplied by baseline usage and fixture flush, flow, or cycle rates. For landscape irrigation, landscape area data are multiplied by typical water use per square foot. Water use is then multiplied by utility water and wastewater cost rates for each space. If a green strategy for plumbing is selected, then reduced flush, flow, or cycle rates are used. If a green strategy for landscape is selected, a corresponding reduced irrigation rate is used. For example, Landscape irrigation quantities also take into account whether a user has selected rainwater collection or grey water reuse as green strategies. A general calculation estimates how much water would be physically available for collection (based on roof area for rainwater, or based on building plumbing usage for grey water).

Databases 604 further include public health data including estimates of pollutants resulting from the construction and operation of the building and corresponding public and occupant health impacts. Such data is derived from Life-Cycle Assessment modeling, other pollutant and health impact estimating techniques, and academic studies.

Databases 604 also include carbon dioxide (CO₂) footprint data including CO₂ output quantities embodied in construction materials, per unit of energy used in building operations, and per residential occupant data for various modes of transportation. Such CO₂ footprint data also includes CO₂ sequestration potential per square foot of landscaping. This CO₂ data is compiled by modeling typical building scenarios using widely accepted methodologies for Life Cycle Assessment (such as the American Center for Life Cycle Assessment methodologies and the ISO Standard 14040-1997). Further, the CO₂ data includes regional consideration of the harvesting of materials or production of energy, transportation of materials or energy, and end-of-life scenarios.

The Major Components also have a significant impact on the building's carbon footprint embodied in materials. Accordingly, for such materials, the system specifically tracks the life cycle carbon embodied in the extraction, manufacture, transportation, construction, operation, and end of life of the materials.

Databases 604 can also include default data including miscellaneous default inputs provided to the user throughout the software to enable the user to run very quick estimates without having to enter all of the details of a particular building. Default inputs can be based on a project location, codes and standards for the project location, other profile factors, or other information, and such default inputs can be regularly updated to reflect market conditions. Further, the default inputs can be modified by the user.

Additionally, databases 604 can include economics and infrastructure data. Such data include information related to wiring, such as phones, cable, internet, control systems, and other installations. Further, such information includes associated costs and life-cycle information associated with such installations. Additionally, databases 604 can include efficiency factors 120 and baselines 124, as well as error margins, such as margins of error 122 depicted in FIG. 1.

User input 710 includes a building profile, which is basic data about the user's particular building project, such as site area, building square footage, number of stories, whether the building is an existing building or a potential new construction project, building location, and construction cost market multiplier. User input 710 further includes utility data, including cost rates for energy, green energy, water, and wastewater (grey water). For an existing building, such utility data can include actual utility bill summaries. Default utility rates are provided, with an attempt to match the user's input location as closely as possible to available data in the energy and water databases.

User inputs 710 further include structure types, such as residential, commercial, retail, or industrial. Further, the user inputs 710 can include material data, financial data, green or environmental strategy data, and other data. In general, the calculations and inputs in a Defining Spaces portion of the user input interface refer to a database of default assumptions about space use (General Space Modeling), including, for example, assumptions about the number of occupants per square foot for each space type, the number of recommended parking spaces per occupant, the number of plumbing fixtures per occupant for each space type, the cost per square foot for each space type, and the like. The user can adjust these assumptions if needed.

Space and material modeling 712 is configured to assemble the project by adding individual spaces and for each space, defining the space type, square footage, number of identical spaces, revenue (rent), rent premium for green features, any fees in addition to utilities, and a breakdown of who pays ongoing costs (e.g., management or tenants). In addition, the user may input the types of materials used for the building structure, façade, and roof. Default values are automatically provided based on a typical construction. For an existing building, the default values may be provided based on when the building was constructed. Since building standards evolve over time, the default values may vary based on when the building was constructed.

In the illustrated embodiment, space and material modeling 712 represents an initial step in the modeling process, which takes the user inputs, such as profile data, spaces data, and material data (and/or some combination of such user inputs and default data) and applies some calculations based on data in databases 604 to estimate useful quantities. Such useful quantities include building footprint data, site open space, roof area, façade area, quantities of materials for the structure, façade, and roof, and other data. Space and material modeling 712 also takes the individual space areas and estimates a number of occupants based on the space type, which number can be used to determine such things as water usage, expected rents, and the like. To the extent that the user input is incomplete, space and material modeling 712 may use defaults data to complete the building profile or may select appropriate data from databases 604 based on building codes associated with a location of a particular building to complete the building profile.

Data from space and material modeling 712 is provided both to advanced modeling tool 704 and to quick modeling tool 706. Both the advanced modeling tool 704 and the quick modeling tool 706 are configured to retrieve a correct baseline factor from baselines 124 and one or more efficiency factors from efficiency factors 120 based on the user input to model an environmental impact of the building.

Advanced modeling tool 704 includes a financial modeling tool, which uses traditional real estate financing calculations to estimate construction costs, cash flow, expenses, and income. Construction costs are calculated by taking the results from space and material modeling 712 and user input and applying costs from the construction cost data of databases 604. In particular, the construction costs can be modeled based on the percentage of major material types, space type cost per square foot, finish out cost, and/or use. Further, detailed construction cost estimates from precedent projects, all can be adjusted with a regional cost multiplier. The choice of materials for major components can result in significant variations in construction cost, so the databases 604 are kept up to date with respect to cost data for structure, façade and roof materials, for example, which are used by advanced modeling tool 704.

A baseline construction cost is calculated excluding green strategies by multiplying the square footage of the building by a selected baseline factor of the baselines 124. Total construction costs, including estimated fees for legal services and architectural design services are added to the land purchase cost or existing building cost. The resulting information is processed using a typical load scenario to estimate a mortgage payment. Green strategies can be applied using selected efficiency factors of the efficiency factors 120 to adjust the costs.

On-going operating expenses are balanced against on-going income from the user input, space information, and revenue data to produce an estimate of cash flow for the building. The estimate is translated using other standard financial calculations to produce an estimated value for the investment. One or more of the efficiency factors 120 can be applied, if green (energy efficiency) strategies are employed, to adjust the operating expenses to reflect such strategies.

Expenses represent on-going operational costs, including repairs, utilities, insurance, management, and any utilities paid for by management. Utilities are calculated by taking the results of the energy and water modeling and by multiplying the energy and water results by the utility rates for the location associated with the building. If one or more green strategies are indicated by the user inputs, the rate of green power is used in proportion to the portion of green power provided. The utility costs are reported for individual spaces so that payment responsibility can be tracked between management and tenants. Baseline utility costs are calculated using baseline energy and water modeling results from baselines 124 and non-green energy rates. The total project and utility costs are then entered into the overall operational costs. If green strategies are employed, such baseline utility costs can be adjusted using efficiency factors 120 to reflect the green strategies.

Income is calculated by taking the user input revenue per space plus any specified premiums (for green strategies using one or more efficiency factors 120) and multiplying these by square footage. Baseline income is calculated by excluding premiums. The results are then entered into the overall project and baseline financial models.

Energy modeling applies the space, number of individuals, usage type, and other information to estimate energy usage for the building, which energy usage is divided into the individual spaces. Water modeling determines water use and conservation potential for a variety of components. For building plumbing fixtures, number of occupants for each space is multiplied by typical usage and fixture flush and flow rates available from the water data in databases 604. If a green strategy for plumbing is selected, then reduced flush and flow rates are applied using one or more of efficiency factors 120. For landscape irrigation, landscape area is multiplied by typical water use per square foot, which water use is reduced using one or more of efficiency factors 120 if a green landscape strategy is used.

Landscape irrigation quantities can also take into account whether the user has selected a rainwater collection or grey water reuse as green strategies. A general calculation estimates how much water would be physically available for collection (based on roof area for rainwater, or based on building plumbing usage for grey water). The user may choose how many green strategies to use. Each green strategy potentially implicates one or more of efficiency factors 120 to adjust the quantities.

Public health modeling estimates public health impacts based on user input, number of tenants, and the like based on pollutants resulting from the construction and operation of the building and corresponding public and occupant health impacts, which can be derived from Life-Cycle Assessment modeling, other pollutant and health impact estimating techniques, and academic studies.

CO₂ modeling estimates carbon footprint data based on quantities embodied in construction materials, per unit of energy used in building operations, and per residential occupant data for various modes of transportation, as well as per square foot of landscaping. Such data can be adjusted using one or more of the efficiency factors 120 based on selected green strategies.

Green ratings modeling can apply any number of algorithms to determine an environmental usage rating, such as Leadership in Energy and Environmental Design (LEED) certifications and/or other ratings or certifications. Further, economics and infrastructure modeling applies the various user inputs and data from databases 604, as well as results from other modeling to produce economics and infrastructure data.

Quick modeling tool 706 can perform similar calculations to advanced modeling tool 704 by applying data from databases 604, relevant ones of efficiency factors 120, and default values to the user inputs and the results from the space and material modeling 712.

Outputs 708 includes an instant feedback module 716 to generate for the building a plurality of outputs, including project costs, carbon footprint, net cash flow, green rating, property values, cost per pound of carbon dioxide that is diverted using particular green strategies, and cost per kilowatt hour saved. Such instant feedback can be provided to the user through a user interface or through a report.

Outputs 708 further includes a recommended strategies module 718, which analyzes the existing building data and available green strategies, incentives, and other data to make recommendations regarding possible green strategies that can improve the on-going costs without adding so much to the up-front construction costs that there would be no return on investment for the owner. Such recommended strategies can take into account the cost per pound of carbon dioxide diverted and the cost per kilowatt hour saved to identify strategies that provide a return on investment (ROI) that is above a pre-determined threshold. In one example, the pre-determined threshold can be a desired period of time over which the initial construction-related investment is expected to be paid off through energy savings. In an embodiment, the desired ROI can be configured by a user through user inputs 710.

Outputs 708 also include a reports module 710, which generates output reports in a variety of formats and for a variety of purposes. Such reports can include appraisal reports, economics analysis reports, LEED reports, LEED checklists, Incentives reports, preliminary design checklists, green tenant lease requirement reports, green product guides, residential health and well-being reports, community benefit reports, and municipal impact reports. Further, reports module 710 can include custom reports, which can be configured by the user to produce a desired output.

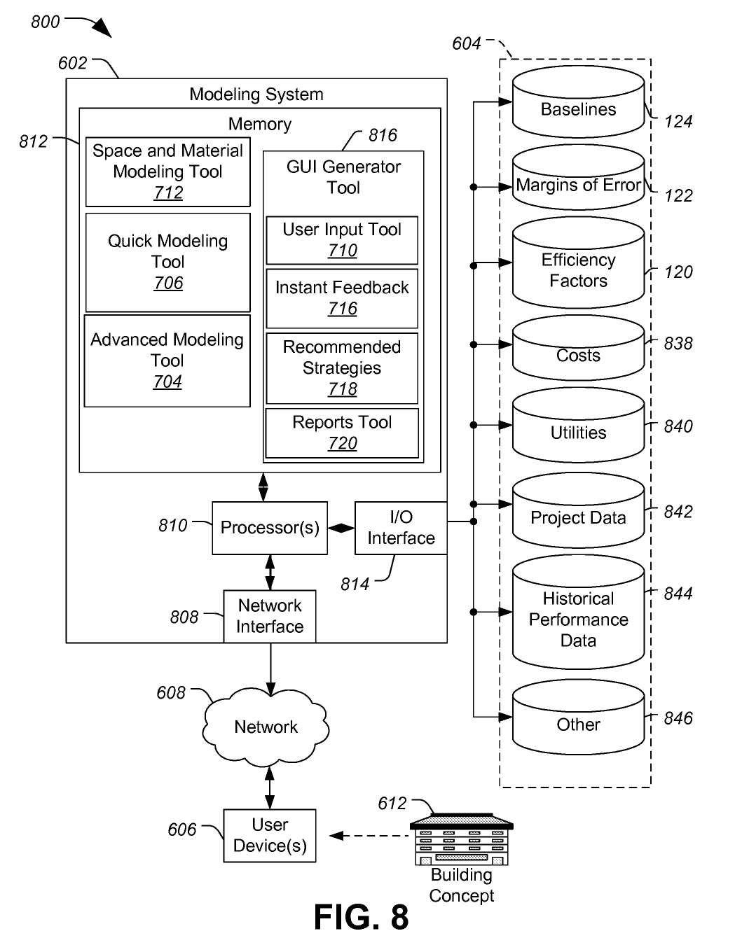

It should be understood that the tools and data flow depicted in FIG. 7 can be distributed across multiple computing systems, such as computer servers in a network environment. Alternatively, the tools and data flow may occur within a single computing system, such as computing system 800 depicted in FIG. 8.

FIG. 8 is a block diagram of an expanded view 800 of the modeling system 602 of FIG. 6 and including an expanded view of the data sources 604. Modeling system 602 includes a network interface 808 communicatively coupled to network 808 and connected to one or more processor 810. One or more processors 810 are coupled to data sources 604 though an input/output (I/O) interface 814 and to a memory 812. In some instances, I/O interface 814 may be omitted and data sources 604 may be connected to modeling system 602 through network 608. In other instances, data sources 604 may be included within memory 812.

Memory 812 includes space and material modeling tool 712, advanced modeling tool 704, quick modeling tool 706, and graphical user interface generator 816. GUI generator 816 includes user input tool 710, instant feedback tool 716, recommended strategies tool 718, and reports tool 720.

In the illustrated embodiment, data sources 604 include baselines 124, margins of error 122, and efficiency factors 120, which store data generated through the iterative modeling process described above with respect to FIGS. 1-5. Further, data sources 604 include a costs database 838, a utilities database 840, and other databases 846 as described above with respect to databases 604 in FIG. 7. Further, data sources 604 include a project database 842, which stores data related to one or more projects created by a user. In one instance, each user may have its own project database 842. In another instance, the project database 842 may store projects associated with multiple unrelated users, and access to the stored data can be controlled through well-known authentication, authorization, and account management techniques so that each user only has access to his/her own project data.

Additionally, databases 604 include historical performance database 844, which stores energy usage and cost data associated with actual buildings. As previously discussed, such performance data can be used to adjust cost and performance calculations.

In operation, processor 810 executes GUI generator 816 to produce a user interface, such as the user interface depicted in FIG. 12, to provide a series of inputs (user inputs tool 710) through which a user can input information relating to a building, such as square footage, geographic region, and usage type information. It should be understood that the user interface includes a plurality of inputs through which a user can provide a complete specification of a building. However, upon receipt of the square footage, geographic region, and usage type information, processor 810 executes at least one of the quick modeling tool 706 and the advanced modeling tool 704 to generate modeling data related to the user input. Further, processor 810 executes instant feedback tool 716, recommended strategies tool 718, and reports tool 720 to provide results data to the user through the user interface.

As the user adds further information to the project, processor 810 applies quick modeling tool 706 and/or advanced modeling tool 704 to calculate environmental and cost impacts of the building based on the additional information. The resulting economic and cost impact information is processed using GUI generator tool 816 to update the user interface with the resulting economic and cost impact data, which may be presented along side of the previously generated environmental and cost impact data to graphically represent the deviation from the baseline. In some instances, the associated margin of error information can be included with the various economic and cost impact data. In such an instance, the margin of error may be graphically rendered or presented as supplemental information along with the presented data.

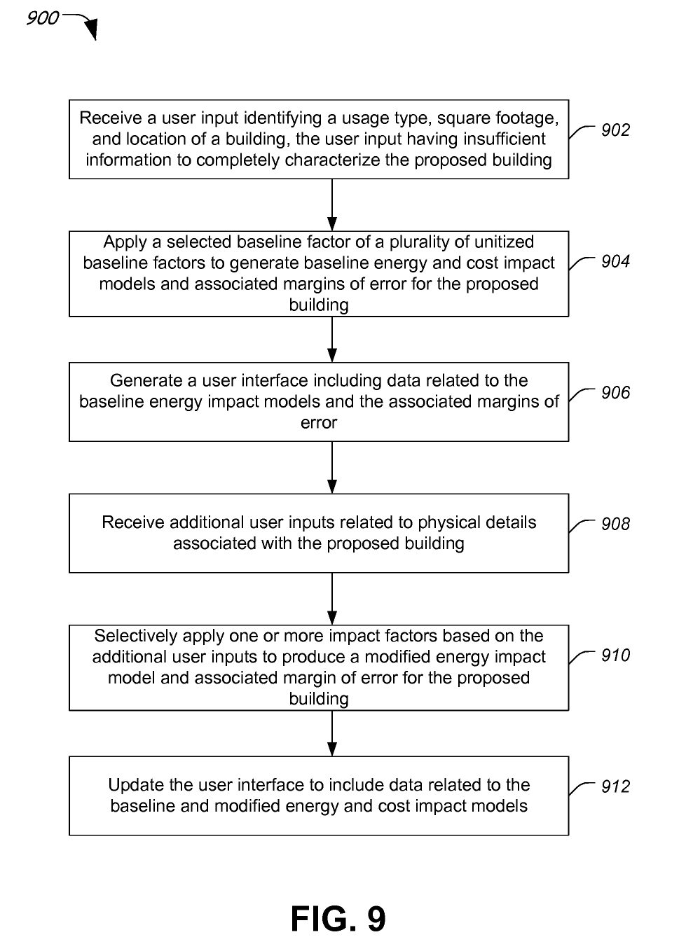

It should be appreciated that the systems 600, 700, and 800, depicted in FIGS. 6, 7, and 8, respectively, are configured to generate environmental and cost impact data based on a complete building profile and/or partial building information. In some instances, the energy usage can be modeled first and costs can be applied to the energy usage model to complete the cost impact data. An example of a method of producing such environmental impact models with such data is described below with respect to FIG. 9.

FIG. 9 is a flow diagram of a second embodiment of a method 900 of modeling energy usage, construction costs, and operational costs for a physical structure. At 902, a user input is received that identifies a usage type, square footage, and location of a building, where the user input has insufficient information to completely characterize the building. Advancing to 904, a selected baseline factor of a plurality of unitized baseline factors is applied to generate a baseline energy impact model and associated margin of error for the building. Moving to 906, a user interface is generated that includes data related to the baseline energy model and the associated margin of error.

Continuing to 908, additional user inputs are received that are related to physical details associated with the building. Proceeding to 910, one or more efficiency factors are selectively applied based on the additional user inputs to produce modified energy impact models and associated margins of error for the building. Moving to 912, the user interface is updated to include data related to the baseline and modified energy models.

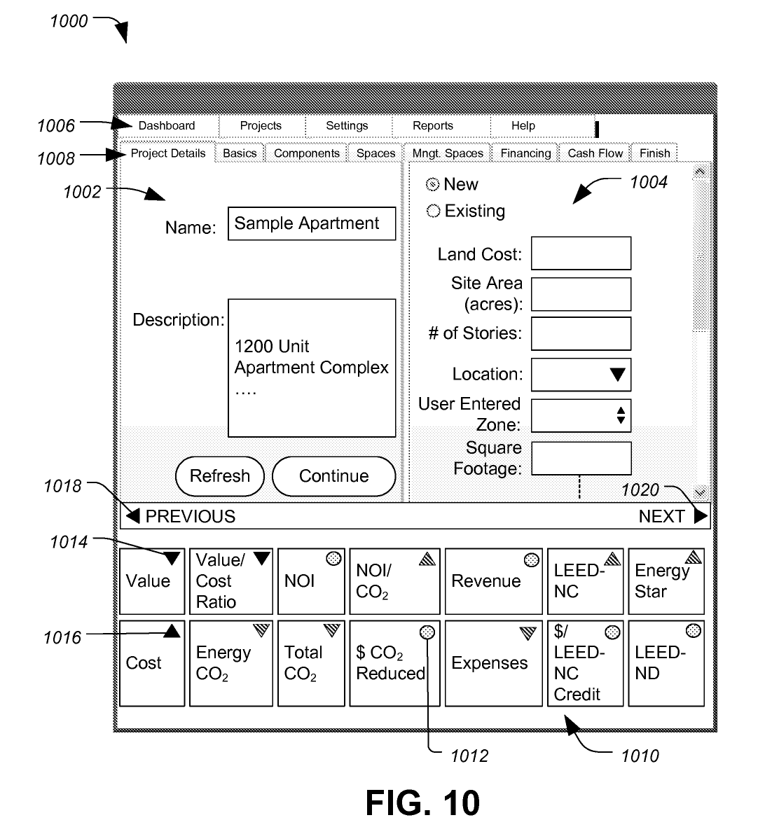

In an embodiment, the above-described method 900 may be performed iteratively. In particular, blocks 908-912 may be performed any number of times as the user continues to update the building project details. Further, the user interface can include a plurality of inputs accessible by a user to define a project profile and associated building details for the purpose of modeling energy impacts. An example of one possible user interface out of many possible user interfaces is disclosed below with respect to FIG. 10. Applicant notes that, in an embodiment, the user interface may be rendered within an Internet browser application using XML pages, scripts, HyperText Markup Language (HTML) files, and other browser-compatible instructions provided by the modeling system 602. Alternatively, such pages and associated data can be served by a computer server, such as an Active Server Pages (ASP)-enabled computing device.

FIG. 10 is a diagram of an embodiment of a user interface 1000 that may be produced by the modeling systems of FIGS. 6-8 to receive user input related to a physical structure and to provide reports related to the modeled energy usage, construction costs, and operational costs for the physical structure. User interface 1000 can utilize any number of input elements, such as text boxes, pull-down menus, check boxes, radio buttons, clickable links, submit and reset buttons, and the like for receiving user input.

In the illustrated embodiment, user interface 1000 includes a project details panel 1002 and a project basics panel 1004. Additionally, user interface 1000 includes menu items 1006 for accessing various functions of the modeling system 602 and includes tabs or panel indication elements 1008 to identify which input page is currently selected with which the user may interact to supply details relating to the project.

Environmental and cost impact results are represented in a results panel 1010, which represents various factors, such as value, cost, value/cost ratio, energy CO₂, net operating income (NOI), total CO₂, NOI/CO₂, cost ($) per unit reduction in CO₂, revenue, expenses, the LEED® for new construction (LEED-NC), cost for each LEED-NC credit, Energy Star analysis, and the LEED® for neighborhood development (LEED-ND), and optionally other results. Within the results panel, change indicators 1012, 1014, and 1016 can be used to indicate how a current building profile compares to a baseline profile. As the user provides more inputs relating to the building, the environmental and cost impact results are updated to reflect the changes, and the indicator is updated to reflect the relative change.

In the illustrated embodiment, a dark indicator, such as indicators 1014 and 1016, represents a greater change than a partially-filled indicator 1012. Additionally, the point of the triangles 1014 and 1016 indicate whether the change represents an increase or decrease relative to the baseline model. A circular indicator 1012 may indicate that the change is neutral relative to the baseline. In an alternative embodiment, a color coding scheme may be used to indicate the relative changes, either by changing the indicator color. Though in the illustrated embodiment the indicator is a shape within a larger box, in an alternative embodiment, the color or order of the larger boxes or a lettering size or color may be adjusted to indicate the relative change.

Further, in the illustrated embodiment, panel identification elements 1008 reflect the selected page. By clicking previous or next elements 1018 and 1020 respectively, the user can navigate between the input panels. In one instance, the user interface is a continuous page that extends vertically and horizontally beyond the viewing window, and horizontal navigation through user interface 1000 is managed using previous and next elements 1018 and 1020 to move horizontally through the possible input panels without having to reload the page. In another instance, a slider bar may be provided to facilitate such horizontal navigation.

In operation, a user can interact with user interface 1000 to enter basic profile information using project details panel 1002 and basics panel 1004, which allows the modeling system 602 to produce the environmental and cost impact data 1010. The user can add additional detailed through the basics panel and through the other panels, including a components panel, a primary/secondary space panel, a management spaces panel, a financing panel, a cash flow panel, and a finish panel. Further, each of the blocks within the results panel 1010 can be accessed by the user to access the specific modeling information.

Further, the user can access a dashboard, other projects, settings, and reports using the menu 1006. Each of the other elements provides access by a user to underlying modeling details, report details, and the like. For example, the reports menu can be accessed by the user to access one or more pre-configured reports.

Additionally, user interface 1000 can include one or more user selectable elements to allow the user to define customized or “add-on” components. For example, proprietary devices and new technologies can be added to the modeling system through the user interface by selecting a similar existing component or device and modifying various parameters associated with the component or device. Such components may be accessed and edited through the settings menu.

Based on information provided by the user through the fields presented within basics panel 1004 of user interface 1000, the modeling system selects a baseline factor and multiplies it by the square footage to determine a baseline energy usage model. Subsequently, the user can provide building details through other panels, including selecting various energy efficiency strategies, and one or more efficiency factors are selected and multiplied by the square footage to produce an adjusted energy usage model. Changes in energy efficiency, value, costs, and other parameters relative to the baseline energy usage model can be reflected as illustrated at 1012, 1014, and 1016.

In conjunction with the systems and methods and user interface depicted in FIGS. 1-10, a system is disclosed that is configured to generate baseline energy and cost impact models for a building based on incomplete information about the building using a unitized baseline that corresponds to input from the user. Further, the baseline models can be adjusted based on further details from the user by selectively applying one or more efficiency factors to produce adjusted models. In some embodiments, baseline models and adjusted models are depicted side-by-side to assist the user in evaluating the energy and cost impacts of various component, system, material, and strategic decisions. Further, indicators may be provided to draw the user's attention to the relative impact of various user selections on the bottom line, e.g. the return on investment for particular construction-related decisions.

Although the present invention has been described with reference to preferred embodiments, workers skilled in the art will recognize that changes may be made in form and detail without departing from the scope of the invention.

What is claimed is:

1. A method of modeling energy consumption of a proposed building from incomplete physical constraint information, the method comprising:
receiving a user input identifying a structure usage type, a square footage, and a geographic zone associated with the proposed building at a modeling system from a user device;
automatically selecting a baseline value from a plurality of baseline values based on the geographic zone and the structure usage type; and
generating a baseline energy impact model associated with the proposed building by multiplying at least a portion of the square footage by the baseline value using the modeling system.

2. The method of claim 1, further comprising selectively multiplying the baseline energy impact model by a baseline construction cost factor and a baseline operating cost factor to generate a baseline cost impact model for the proposed building.

3. The method of claim 2, further comprising:
generating a user interface including data related to the baseline energy impact model and the cost impact model; and
sending the user interface to the user device.

4. The method of claim 1, further comprising:
receiving a second user input related to the proposed building from the user device;
selecting an efficiency factor from a plurality of efficiency factors based on the second user input; and
modifying the baseline energy impact model based on the efficiency factor to produce an adjusted energy impact model associated with the proposed building.

5. The method of claim 4, wherein each of the plurality of efficiency factors represents a percentage change in energy consumption attributable to one or more building parameters normalized by square footage.

6. The method of claim 4, wherein modifying the baseline energy impact model comprises:
multiplying the efficiency factor by the square footage to determine an adjusted energy impact value; and
subtracting the adjusted energy impact value from the baseline energy impact model to produce the adjusted energy impact model.

7. The method of claim 1, wherein, before receiving the user input, the method further comprises:
generating a plurality of energy usage values for a respective plurality of building definitions, each energy usage value comprising a number of units of energy used per year for a respective one of the plurality of building definitions; and
normalizing each of the plurality of energy usage values over a respective square footage parameter of the respective one of the plurality of building definitions to generate the plurality of baseline values.

8. The method of claim 7, further comprising:
determining a change in energy usage attributable to a change in at least one building parameter of a respective building definition; and
normalizing the change over the respective square footage of the respective one of the plurality of building definitions to produce an efficiency factor; and
repeating iteratively the steps of determining the change and normalizing the change for a plurality of changed building parameters to produce a plurality of efficiency factors.

9. The method of claim 7, wherein generating the plurality of energy usage values comprises:
selecting one of the plurality of building definitions;
modeling the one of the plurality of building definitions using the modeling tool to produce an energy usage value; and
iteratively selecting and modeling each of the plurality of building definitions to produce the plurality of energy usage values.

10. The method of claim 7, further comprising:
selecting a second modeling tool from the plurality of modeling tools; and
repeating the steps of selecting and modeling for each of the plurality of building definitions to produce additional energy usage values; and
adding the additional energy usage values to the plurality of energy usage values.

11. A system for modeling energy consumption of a proposed building to be built or renovated, the system comprising:
a processor; and
a memory accessible to the processor and having stored therein a plurality of instructions that, when executed by the processor, cause the processor to:
receive a user input identifying a structure usage type, a location, and a square footage associated with the proposed building, the user input providing incomplete physical constraint information about the physical structure;
determine a baseline energy usage model based on the user input by applying a baseline value of a plurality of baseline values based on the structure usage type and the location; and
selectively apply one or more efficiency factors of a plurality of impact values based on the user input to produce an adjusted energy usage model.

12. The system of claim 11, wherein the memory further includes instructions that, when executed by the processor, cause the processor to:
generate a user interface including data related to the baseline energy impact model and to the adjusted baseline model.

13. The system of claim 12, further comprising:
a network interface configurable to be coupled to a remote device through a network;
wherein the memory further includes instructions that, when executed by the processor, cause the processor to:
provide the user interface to the network interface for transmission to the remote device.

14. The system of claim 11, wherein the memory further includes instructions that, when executed by the processor, cause the processor to:
receive additional user inputs related to the proposed building;
determine an efficiency factor based on the additional user inputs, the location and the structure usage type; and
apply the efficiency factor to the square footage to produce an adjusted energy usage value, and
subtract the adjusted energy usage value from one of the baseline energy usage model or the adjusted energy usage model to produce a second adjusted usage model.

15. The system of claim 11, wherein the memory further includes instructions that, when executed by the processor, cause the processor to:
model multiple building definitions and variations thereof using one or more modeling tools to produce multiple energy usage models;
normalize each of the multiple energy usage models over a respective square footage associated with a respective one of the multiple building definitions to produce a plurality of baseline values;
determine a percentage performance energy efficiency attributable to each energy efficiency strategy applied to each of the multiple building definitions; and
normalize the percentage performance efficiency over the square footage to produce the plurality of efficiency factors.

16. The system of claim 11, wherein each of the plurality of efficiency factors represents a percentage change in energy usage attributable to a particular energy efficiency strategy normalized over square footage.

17. A computer readable medium embodying data comprising instructions that, when executed by a processor, cause the processor to:
receive a user input identifying a structure usage type, a square footage, and a geographic zone associated with a proposed building;
automatically select a baseline value from a plurality of baseline values based on the geographic zone and the structure usage type; and
generate a baseline energy model associated with the proposed building by multiplying at least a portion of the square footage by the baseline value.

18. The computer readable medium of claim 17, wherein the data further comprises the plurality of baseline values representing energy usage values normalized over square footage for a plurality of building definitions.

19. The computer readable medium of claim 18, wherein the data further comprises:
a plurality of efficiency factors, each of the plurality of efficiency factors representing a percentage performance energy efficiency factor attributable to a particular energy efficiency strategy normalized over square footage.

20. The computer readable medium of claim 19, wherein the data further comprises instructions that, when executed by the processor, cause the processor to:
generate a user interface including user-selectable elements for receiving user input related to a proposed building, the user input being insufficient to fully characterize the proposed building;
model the proposed building by selectively applying a baseline value from the plurality of baseline values and at least one efficiency factor of the plurality of efficiency factors based on the user input to produce an adjusted energy usage impact model for the proposed building.

21. The computer readable medium of claim 20, wherein the data further comprises instructions that, when executed by the processor, cause the processor to:
receive additional user inputs and to update the energy usage impact model in response to receiving the additional user inputs.

22. The computer readable medium of claim 20, wherein the data further comprises instructions that, when executed by the processor, cause the processor to:
generate a user interface including a dashboard indicator to graphically depict a change in at least one of an environmental parameter and a cost parameter associated with differences between the baseline energy model and the adjusted energy usage impact model caused by the additional user inputs.
